(19) United States
(12) Patent Application Publication
(10) Pub. No.: US 2003/0155681 A1
(43) Pub. Date: Aug. 21, 2003

(54) Pulverulent binder composition

(75) Inventors: Peter Weiler, Geretstried (DE); Ulf Dietrich, Altotting (DE); Rene Graewe, Vilsbiburg (DE)

Correspondence Address: BROOKS & KUSHMAN, 1000 TOWN CENTER 22ND FL, SOUTHFIELD, MI, 48075

(73) Assignee: Wacker Polymer Systems GmbH & Co. KG, Burghausen (DE)

(21) Appl. No.: 10/351,200

(22) Filed: Jan. 23, 2003

(30) Foreign Application Priority Data
Feb. 14, 2002 (DE) 102 06 126.2

(51) Int. Cl. B28B 7/36

(52) U.S. Cl. 264/109; 106/38.22

(57) ABSTRACT

Pulverulent compositions for binding particulates, comprise A) 10 to 99.99 parts of at least one pulverulent interpolymer having a glass transition temperature Tg or a melting temperature of ≧30° C. and containing units derived from a1) comonomer(s) of vinyl esters of optionally branched C₁₋₁₈ alkylcarboxylic acids, (meth)acrylic esters of optionally branched C₁₋₁₅ alcohols, dienes, olefins, vinyl aromatics or vinyl halides, and a2) from 0.1 to 50% by weight, based on the total comonomer weight, of ethylenically unsaturated functional comonomers; B) 0 to 89.99 parts by weight of a pulverulent compound which bears two or more functional groups capable of reacting with functional groups of interpolymer A); and C) 0.01 to 90 parts by weight of a melt viscosity depressant having a glass transition temperature Tg or a melting temperature of ≦150° C.

### BACKGROUND OF THE INVENTION

1. Field of the Invention

This invention relates to a pulverulent composition for binding particulate materials, especially fibers.

2. Background Art

It is known to use crosslinkable polymer powders to produce fibrous moldings. EP-A 894888 recommends for this purpose a powder mix which contains a carboxyl-functional interpolymer and a pulverulent compound containing two or more crosslinking epoxy or isocyanate groups. EP-A 1136516 discloses fiber binding using polymer powders comprising a carboxyl-functional interpolymer and a further interpolymer which contains functional groups which enter into covalent bonds with carboxyl groups. Such crosslinkable powder binders, when used for fiber binding, may in certain circumstances, be unsatisfactory with regard to distribution in the fibrous web or with regard adhesion to the fibers.

EP-B 257567 describes a method of producing high molecular weight emulsion copolymers which are useful, in particular, for coating applications. Copolymerization takes place in the presence of a low molecular weight polymer which is soluble or dispersible in water or alkali. This measure provides, inter alia, newtonian flow properties and better wetting properties.

U.S. Pat. No. 5,314,943 describes a crosslinkable formaldehyde-free fiber binder comprising a mixture of an emulsion polymer and a solution polymer having a high proportion of carboxyl groups. Good binder wetting of the fiber is obtained by limiting the proportion of the low molecular weight solution polymer.

### SUMMARY OF THE INVENTION

It is an object of the present invention to provide pulverulent binders which, when applied, exhibit improved distribution in and improved adhesion to the particulate materials to be bound. It has now been surprisingly discovered that these and other objects are achieved by the use of binder compositions which include additives to reduce the melt viscosity of the binders. Use of the binder compositions enable production of moldings of higher strength.

### BRIEF DESCRIPTION OF THE DRAWINGS

FIGS. 1 and 2 illustrate the depression in melt viscosity possible when component C) is present during polymerization of monomers to form component A.

FIGS. 3 and 4 illustrate the depression in melt viscosity possible when optional component B) is employed with components A) and C).

### DETAILED DESCRIPTION OF THE PREFERRED EMBODIMENT(S)

The invention provides a pulverulent composition for binding particulate materials, comprising

A) 10 to 99.99 parts by weight of at least one pulverulent interpolymer having a glass transition temperature Tg or a melting temperature of ≧30° C., and containing units derived from one or more comonomers a1) selected from the group consisting of vinyl esters of branched or unbranched alkylcarboxylic acids of 1 to 18 carbon atoms, acrylic esters or methacrylic esters of branched or unbranched (“optionally branched”) alcohols of 1 to 15 carbon atoms, dienes, olefins, vinyl aromatics and vinyl halides, and a2) from 0.1 to 50% by weight, based on the total weight of the comonomers, of one or more ethylenically unsaturated functional comonomers;

B) 0 to 89.99 parts by weight of at least one pulverulent compound which bears two or more functional groups capable of entering into a covalent bond with the functional groups of interpolymer A); and

C) 0.01 to 90 parts by weight of at least one additive selected from the group of polyesters, polyamides, polyethers, polyolefins, polyvinyl alcohols, polyvinyl esters, polyvinyl acetals, fatty alcohols and their esters, fatty acids and their esters, amides, and metal soaps, montan acids and their esters and soaps, and paraffins, each having a glass transition temperature Tg or a melting temperature of ≦150° C., the parts by weight totaling 100 parts by weight.

Useful vinyl esters include vinyl esters of branched or unbranched carboxylic acids of 1 to 18 carbon atoms. Preferred vinyl esters are vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids of 9 to 11 carbon atoms, for example VeoVa9^{R} or VeoVa10^{R} (trade names of Shell). Vinyl acetate is particularly preferred.

Useful monomers from the group of the esters of acrylic acid or methacrylic acid include esters of branched or unbranched alcohols of 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, 2-ethylhexyl acrylate, and norbornyl acrylate. Particular preference is given to methyl acrylate, methyl methacrylate, n-butyl acrylate, 2-ethylhexyl acrylate and norbornyl acrylate.

Useful dienes include 1,3-butadiene and isoprene. Examples of copolymerizable olefins are ethene and propene. Copolymerizable vinyl aromatics include styrene and vinyltoluene. Vinyl chloride is the customary vinyl halide. The monomers listed above in each category are illustrative, and not limiting.

Useful ethylenically unsaturated functional comonomers a2) are comonomers having one or more functional groups selected from the group consisting of carboxyl groups, hydroxyl groups, amino groups, amido groups, especially N-alkylolamide groups and groups derived therefrom, carbonyl groups, alkoxysilane groups, epoxy groups, isocyanate groups, oxazoline groups, aziridine groups, and combinations of the functional comonomers just mentioned.

Examples of carboxyl-functional comonomers include acrylic acid, methacrylic acid, maleic acid, fumaric acid, crotonic acid, and itaconic acid, the monoesters of maleic and fumaric acids, monovinylsuccinic esters, and methylenemalonic acid.

Useful hydroxyl-functional comonomers include for example hydroxyalkyl (meth)acrylates such as hydroxyethyl (meth)acrylate, hydroxypropyl (meth)acrylate and hydroxybutyl (meth)acrylate. Examples of comonomers having amine groups are allylamine and 2-aminoethyl (meth)acrylate. Amido-functional comonomers include, for example, acrylamide, methacrylamide, N-methylolacrylamide and N-methylolmethacrylamide and their alkyl ethers such as their isobutoxy ethers or n-butoxy ethers, acrylamidoglycolic acid, methyl methacrylamidoglycolate, and allyl N-methylolcarbamate. Examples of carbonyl comonomers are vinyl acetoacetate, allyl acetoacetate, vinyl bisacetoacetate, allyl bisacetoacetate, acrolein, allylsuccinic anhydride and maleic anhydride.

Useful alkoxysilane-functional comonomers include acryloyloxypropyltri(alkoxy)silanes, methacryloyloxypropyltri(alkoxy)silanes, vinyltrialkoxysilanes and vinylmethyldialkoxysilanes, for example vinyltriethoxysilane and gamma-methacryloyloxypropyltriethoxysilane. Epoxy-containing comonomers include for example glycidyl acrylate, glycidyl methacrylate, glycidyl vinyl ether and glycidyl allyl ether.

Useful isocyanate monomers include meta- and para-isopropenyl-alpha,alpha-dimethylbenzyl isocyanate (TMI), and 2-methyl-2-isocyanatopropyl methacrylate. The isocyanate groups on the isocyanate monomers may be blocked, if desired.

Preference is given to the interpolymers A) described below which additionally contain the appropriate fractions of comonomer component a2). The weight percentages and the fraction of functional comonomer units a2) add up to 100% by weight in each case. Preferred, therefore, are vinyl acetate polymers; vinyl ester-ethylene copolymers such as vinyl acetate-ethylene copolymers; vinyl ester-ethylene-vinyl chloride copolymers where the vinyl ester component is preferably vinyl acetate and/or vinyl propionate and/or one or more copolymerizable vinyl esters such as vinyl laurate, vinyl pivalate, vinyl 2-ethylhexanoate, vinyl esters of an alpha-branched carboxylic acid, especially vinyl versatate (VeoVa9^{R}, VeoVa10^{R}); vinyl acetate copolymers with one or more copolymerizable vinyl esters such as vinyl laurate, vinyl pivalate, vinyl 2-ethylhexanoate, or vinyl esters of alpha-branched carboxylic acids, especially vinyl versatate (VeoVa9^{R}, VeoVa10^{R}), optionally containing ethylene as well; vinyl ester-acrylic ester copolymers, especially those containing vinyl acetate and butyl acrylate and/or 2-ethylhexyl acrylate, optionally containing ethylene as well; vinyl ester-acrylic ester copolymers with vinyl acetate and/or vinyl laurate and/or vinyl versatate and acrylic esters, especially butyl acrylate or 2-ethylhexyl acrylate, optionally containing ethylene as well.

Particular preference is given to (meth)acrylic acid and styrene polymers, for example copolymers of the latter with n-butyl acrylate and/or 2-ethylhexyl acrylate; copolymers of methyl methacrylate with butyl acrylate and/or 2-ethylhexyl acrylate and/or 1,3-butadiene; styrene-1,3-butadiene copolymers and styrene-(meth)acrylic ester copolymers such as styrene-butyl acrylate, styrene-methyl methacrylate-butyl acrylate or styrene-2-ethylhexyl acrylate, where the butyl acrylate used can be n-, iso-, or tert-butyl acrylate.

Preferably the comonomers in the above-indicated copolymers are copolymerized in such a ratio that the interpolymer A) has a melting point or a glass transition temperature Tg of ≧45° C.

Preferred functional comonomers a2) are the carboxyl-functional comonomers, the hydroxyl-functional comonomers, N-methylol(meth)acrylamide and its ethers, and epoxy-functional comonomers. Preference is also given to combinations of hydroxyl- and epoxy-functional comonomers. These comonomers are preferably included in an amount of 1 to 20% by weight, based on the total weight of the comonomers a).

The choice of the crosslinking component B) depends on the functionality of component A). The compounds B) used have functional groups which will enter into covalent bonds with the functional groups of component A) via addition reactions or condensation reactions. Useful crosslinkers B) include, for example, pulverulent compounds having two or more epoxy or isocyanate groups and a melting point of 40° C. to 150° C. The amount of these crosslinkers is preferably in the range from 0.1 to 50 parts by weight.

Epoxy compounds can esterify with carboxyl-functional interpolymers A), etherify with hydroxyl-functional interpolymers A) or react with amino-functional interpolymers A). Examples of suitable epoxy type crosslinkers are those of the bisphenol A type, e.g. condensation products of bisphenol A and epichlorohydrin or methylepichlorohydrin. These epoxy type crosslinkers are commercially available, for example under the trade names Epikote or Eurepox. Triglycidyl isocyanurate is also suitable as an epoxy-functional crosslinker.

Compounds containing isocyanate groups can react with carboxyl-functional interpolymers A), with amino-functional interpolymers A) or with hydroxyl-functional interpolymers A). Suitable diisocyanates are likewise common commercial products, for example m-tetramethylxylene diisocyanate (TMXDI), and methylenediphenyl diisocyanate (MDI).

Useful crosslinkers B) also include interpolymers which, with regard to the base monomers, can have the same base composition as the interpolymers A), e.g. interpolymers B) of one or more monomers b1) selected from the group consisting of vinyl esters of branched or unbranched alkylcarboxylic acids of 1 to 18 carbon atoms, acrylic esters or methacrylic esters of branched or unbranched alcohols of 1 to 15 carbon atoms, dienes, olefins, vinyl aromatics and vinyl halides. Useful functional groups b2) capable of entering into a covalent bond with the functional groups of interpolymer A) include the same ones as already mentioned as comonomers a2), in the same amounts as mentioned above. The choice is made so that the functional comonomer units b2) of the interpolymer B) will form covalent bonds with the functional comonomer units a2) of the interpolymer A) via addition or condensation reaction. Preferred combinations are carboxyl-functional interpolymers A) with interpolymers B) which contain epoxy-, hydroxyl-, amino- or isocyanate-functional comonomer units; and also hydroxyl-functional interpolymers A) with interpolymers B) which contain epoxy-, alkoxysilane-, N-methylol- or isocyanate-functional comonomer units; and also amine-functional interpolymers A) with interpolymers B) which contain epoxy-, alkoxysilane-, carboxyl- or isocyanate-functional comonomer units.

When combinations of the interpolymers A) and B) are used, the interpolymers A) and B) are preferably present in such a ratio that the molar ratio of functional comonomer units of copolymer A) to copolymer B) is in the range from 5:1 to 1:5. The copolymers A) and B) are selected for the polymer composition so that they are compatible with each other, i.e. miscible with each other at the molecular level. The usual procedure is therefore to polymerize the copolymers A) and B) which are present in the polymer composition largely from the same comonomer units, apart from the complementary functional comonomer units.

Greatest preference is given to compositions with carboxyl-functional styrene-(meth)acrylic ester copolymers, especially styrene-butyl acrylate and/or styrene-methyl methacrylate-butyl acrylate copolymers having acrylic acid units or with carboxyl-functional vinyl ester copolymers, especially vinyl acetate or vinyl acetate-ethylene copolymers with crotonic acid or acrylic acid units as interpolymer A); and with glycidyl-methacrylate-containing styrene-(meth)acrylic ester copolymers, especially styrene-butyl acrylate and/or styrene-methyl methacrylate-butyl acrylate copolymers or epoxy-functional vinyl ester copolymers, especially allyl-glycidyl-ether-containing vinyl acetate or vinyl acetate-ethylene copolymers as interpolymer B).

The interpolymers A) and B) may be prepared using existing free-radically initiated polymerization processes, for example by solution polymerization, aqueous suspension polymerization, or aqueous emulsion polymerization. Preference is given to suspension polymerization and emulsion polymerization. The solutions or dispersions can be dried using any common drying process: spray drying, roller drying, freeze drying, belt drying, or coagulation with subsequent fluidized bed drying. Preference is given to using spray drying and roller drying processes. Such processes are described in EP-B 1046737, for example.

Particularly useful components C) are those which are soluble in the monomers a1), if appropriate b1) or mixtures thereof, i.e. those having a solubility at 20° C. of more than 10% by weight, based on the amount of monomer a1) and if appropriate b1). A component C) which meets these requirements provides water-clear melts (same refractive index) for the pulverulent binder composition. When component C) is not soluble in the monomers a1) and b1), it should preferably be chosen so that it is miscible with the dispersions of the interpolymers A) and B) when in the form of an aqueous dispersion. These preferred features provide for homogeneous blending and thus for better efficiency in relation to reduction in melt viscosity.

Preferred choices for component C) vary with the composition of interpolymer A). Polyvinyl alcohols, polyvinyl esters, polyvinyl acetals and fatty acid esters are preferred for use with vinyl ester polymers. Polyesters and fatty acid esters are preferred for use with (meth)acrylic ester polymers. Polyesters, polyolefins, polyvinyl alcohols, polyvinyl esters, polyvinyl acetals and fatty acid esters are preferred for use with polymers which contain butadiene. It is preferable to use polyesters, polyvinyl alcohols, polyvinyl esters, polyvinyl acetals and fatty acid esters for use with styrene copolymers with (meth)acrylic esters.

Polyesters preferred for use as component C) are the esterification products of di- or trifunctional aliphatic or cycloaliphatic alcohols such as ethylene glycol, diethylene glycol, butylene glycol, cyclohexanedimethanol and hexanetriol with a dibasic carboxylic acid such as adipic acid, phthalic acid, terephthalic acid, or anhydrides thereof, these polyesters preferably having an Mw of 2000 to 300,000.

Preferred polyamides are polytetramethyleneadipamide (N 4.6), polycaprolactam (N 6), polyhexamethyleneadipamide (N 6.6), polyhexamethylenesebacamide (N 6.10), polyaminoundecanoic acid (N 11) and polylaurolactam (N 12).

Preferred polyethers are polyoxyalkylene glycols of ethylene oxide (EO) or propylene oxide (PO), and EO-PO interpolymers. Preferred polyolefins are polar and apolar polyethylene waxes, polypropylene and polyisoprene.

Preferred polyvinyl alcohols are polyvinyl alcohols and ethylene-vinyl alcohol copolymers having a degree of hydrolysis of 20 to 100 mol % and an Mw of 3000 to 500,000.

Preferred polyvinyl esters are polyvinyl acetate and ethylene-vinyl acetate copolymers having an Mw of 5000 to 3,000,000.

Preferred polyvinyl acetals are polyvinyl acetoacetal and polyvinyl butyral having an Mw of 10,000 to 500,000.

Suitable fatty alcohols include cetyl alcohol and stearyl alcohol. Suitable fatty acids include stearic acid and 12-hydroxystearic acid. Examples of fatty acid esters are hydrogenated castor oil, glycerol monostearate, glycerol tristearate and also fatty acid complex esters such as stearic esters and oleic esters, or fatty alcohol fatty acid esters such as cetyl palmitate and cetyl stearate. Oleamide is a suitable fatty acid amide. Suitable metal soaps include the stearates of calcium or zinc. Examples of montan acids and their esters and soaps are montan acid and glyceryl montanate. Preference is given to fatty acid esters such as hydrogenated castor oil, for example in the form of hydrogenated castor oil (HCO) flakes.

Greatest preference is given to the polyesters and fatty acid esters previously mentioned. The polymers and compounds mentioned for use as component C) are commercially available and preparable using processes known to one skilled in the art. They may be used individually or as mixtures.

Component C) is preferably used in an amount of 0.01 to 60 parts by weight. The amount used depends on the rheological flow behavior of the constituents A) and B) of the pulverulent composition and on the processing conditions under which the powder composition is produced. Component C) is used in the binder composition in such an amount that the melt viscosity of the liquid mixture is ≦5·10⁴ Pas at 150° C.

Component C) can be mixed as a powder with component A) and, if used, component B). The component C) can also be added during the polymerization of the interpolymers A) or B). As mentioned above, component C) should in this case be soluble in the monomers a1) and b1) or be miscible with the dispersions of the interpolymers A) and B) when in the form of an aqueous dispersion. Aqueous dispersions of the component C) can also be mixed with the aqueous dispersions of the interpolymers A) or B) prior to the drying thereof. A further option is for the components A), optionally B), and C) to be coextruded in the form of their melts and the solidified product subsequently ground.

The binder composition is useful for producing moldings from particulate materials such as fibers or particulates composed of mineral materials, synthetic materials, or natural materials, such as wood shavings, cork particles, glass particles or glass powders, especially recycled-content glass and hollow glass balls, or combinations of these materials. The preferred use is that as a binder for fiber materials. Useful fiber materials include both natural and synthetic fibers. Examples thereof are manufactured fibers based on fiber-forming polymers such as viscose fibers, polyester fibers such as chaffcut polyester fibers, polyamide fibers, polypropylene fibers, and polyethylene fibers. It is also possible to use mineral fibers such as glass fibers, ceramic fibers, and carbon fibers. Examples of natural fiber materials are wood fibers, cellulose fibers, wool fibers, cotton fibers, jute fibers, flax fibers, hemp fibers, coir, ramie fibers and sisal fibers. The fibers can also be used in the form of woven textiles, in the form of yarns or in the form of nonwovens such as nonwoven scrims or formed-loop knits. These nonwovens may optionally be mechanically preconsolidated, for example by needling.

Depending on the intended use, the moldings may be produced at room temperature or at elevated temperature, under atmospheric or under elevated pressure. The temperature for consolidating the moldings is generally in the range of from 20° C. to 220° C. When an elevated temperature is used, it is preferably in the range of from 90 to 220° C. When the moldings are produced under pressure it is preferable to employ pressures of 1 to 200 bar. The binder composition is generally used in an amount of 5 to 50% by weight, based on the material to be bound. The binder quantity depends on the substrate to be bound and is preferably between 10 and 40% by weight in the case of polyester fibers and cotton fibers, and preferably in the range of from 20 to 40% by weight in the case of natural fibers such as hemp, flax, sisal, or jute, for example for use in automotive interior applications. In the case of glass and mineral fibers and also in the case of other mineral materials such as glass balls, the preferred range is between 10 and 30% by weight. A further application is the production of high density and medium density fiberboard and of wood extrudates, for which the binder composition is mixed with wood particles and subsequently extruded.

To produce moldings from fiber materials, the pulverulent binder composition is mixed with the fibers and the fiber-powder mixture is spread out by the customary methods of nonwovens technology, optionally after carding of the fiber-powder mixture and/or needling, and bonded at elevated temperature, optionally with the aid of pressure and/or superheated steam. The fiber bonding or binding may also be effected by sprinkling the pulverulent binder composition into a woven fabric, a nonwoven scrim or a previously deposited fiber bed (optionally after carding of the fiber-powder mixture and/or needling), and the binding powder melted and cured at elevated temperature elevation, again, if appropriate, with the aid of pressure and/or superheated steam.

### EXAMPLES

### Example 1

### Preparation of Polyester P1

1500 g of 1,4-cyclohexanedimethanol (mol. wt.=144.2 g/mol, 10.4 mol) were melted at 100° C. and introduced into a 4 l three-neck flask as an initial charge. Thereafter, 1540 g of phthalic anhydride (mol. wt.=148.1 g/mol, 10.4 mol) were introduced into the flask with slow stirring. The temperature was raised to 100° C. and, owing to the heat of reaction, continued to rise. After the initial reaction (ring opening of the phthalic anhydride) had slowly died down, the temperature was raised to 180° C. At 180° C., the water of reaction formed was removed by vacuum distillation over a period of 3 to 6 hours. The esterification was accelerated in a conventional manner by addition of catalysts (p-TosOH, transition metal ions, Ti³+). To improve the removal of the water of reaction, some toluene was repeatedly added (azeotrope). After 2 hours, a further 20 g of phthalic anhydride were added for a very complete reaction. Thereafter, the product was poured, while still hot, into a container and subsequently cooled to room temperature. The polyester obtained was amorphous and had a glass transition temperature of 51° C. and a weight average molecular weight Mw of 5400 g mol⁻¹, Z-average molecular weight M_{z} of 8800 g mol⁻¹, and number average molecular weight Mn of 830 g mol⁻¹.

### Example 2

### Preparation of Self-crosslinking Suspension Polymer S1

A 2 liter reactor was charged with 868.7 kg of deionized water, 44.7 g of 1% aqueous copper acetate solution, 107.4 g of 5% polyvinylpyrrolidone solution (K 90), 13.4 g of methacrylic acid, 4.5 g of dodecyl mercaptan, 161.1 g of butyl acrylate, 697.9 g of styrene and 22.4 g of glycidyl methacrylate. The pH of the mixture was adjusted to 4.5. After addition of the initiators: 14.5 g of tert-butyl peroxyneodecanoate (75% solution in aliphatics), 10.7 g of tert-butyl peroxypivalate (75% solution in aliphatics) and 8.2 g of tert-butyl peroxy-2-ethylhexanoate, the mixture was heated to 55° C. with stirring. After 4 hours, the reaction temperature was raised to 70° C. and, after a further 4 hours, to 90° C. After the reaction had ended, the residual monomer was removed by steam stripping at 60° C. for 4 hours. The batch was then cooled down and the suspension polymers were washed with deionized water, filtered off with suction and dried. The K value was 37.

### Example 3

### Preparation of a Self-crosslinking Suspension Polymer S1 in the Presence of the Polyester P1=S1(P1)

A 2 liter reactor was charged with 868.7 kg of deionized water, 44.7 g of 1% aqueous copper acetate solution, 107.4 g of 5% polyvinylpyrrolidone solution (K 90), 13.4 g of methacrylic acid, 4.5 g of dodecyl mercaptan, 161.1 g of butyl acrylate, 697.9 g of styrene and 22.4 g of glycidyl methacrylate and 89.5 g of polyester P1. The pH of the mixture was adjusted to 4.5. After addition of the initiators 14.5 g of tert-butyl peroxyneodecanoate (75% solution in aliphatics), 10.7 g of tert-butyl peroxypivalate (75% solution in aliphatics) and 8.2 g of tert-butyl peroxy-2-ethylhexanoate, the mixture was heated to 55° C. with stirring. After 4 hours, the reaction temperature was raised to 70° C. and, after a further 4 hours, to 90° C. After the reaction had ended, the residual monomer was removed by steam stripping at 60° C. for 4 hours. The batch was then cooled down and the suspension polymers were washed with deionized water, filtered off with suction and dried. The K value was 34.

### Example 4

### Preparation of a Self-crosslinking Suspension Polymer S1 in the Presence of an Incompatible Polyester P2 (2-hexanedecanyl trimellitate)=S1(P2)

A 2 liter reactor was charged with 862.6 kg of deionized water, 46.8 g of 1% aqueous copper acetate solution, 112.4 g of 5% polyvinylpyrrolidone solution (K 90), 14.1 g of methacrylic acid, 4.7 g of dodecyl mercaptan, 168.6 g of butyl acrylate, 730.6 g of styrene, 23.4 g of glycidyl methacrylate and 46.8 g of polyester P2 (2-hexanedecanyl trimellitate). The pH of the mixture was adjusted to 4.5. After addition of the initiators 15.2 g of tert-butyl peroxyneodecanoate (75% solution in aliphatics), 11.2 g of tert-butyl peroxypivalate (75% solution in aliphatics) and 8.6 g of tert-butyl peroxy-2-ethylhexanoate, the mixture was heated to 55° C. with stirring. After 4 hours, the reaction temperature was raised to 70° C. and, after a further 4 hours, to 90° C. After the reaction had ended, the residual monomer was removed by steam stripping at 60° C. for 4 hours. The batch was then cooled down and the suspension polymers washed with deionized water, filtered off with suction and dried. The K value was 32.

### Example 5

### Preparation of a Carboxyl-functional Styrene-butyl Acrylate-methacrylic Acid-acrylamide Interpolymer E1

In a 3 liter capacity reactor, 838.8 g of deionized water and 6.7 g of sodium lauryl sulfate were heated to 80° C. under nitrogen with stirring. At 80° C. the initiator solution (6.7 g of potassium peroxodisulfate and 218.4 g of water) was introduced into the reactor and the following compositions were metered into the reactor from separate containers in the course of 4 hours: Monomer feed 1 with 67.3 g of methacrylic acid, 403.7 g of butyl acrylate, 861.3 g of styrene and 6.7 g of dodecyl mercaptan; Monomer feed 2 with 67.3 g of water, 44.9 g of a 30% aqueous acrylamide solution, and an initiator feed with 217.6 g of water and 6.7 g of potassium peroxodisulfate. Afterward the batch was supplementarily polymerized at 80° C. for about 2 hours and adjusted to pH 8 with ammonia.

Spray drying afforded a free-flowing powder having a volume average particle size of about 30 μm.

### Example 6

### Preparation of an Emulsion Polymer E1 with Polyester P1=E1(P1)

A 16 liter reactor was charged with 3.57 kg of deionized water, 92.9 g of sodium lauryl sulfate and 387.0 g of 40% tert-butyl hydroperoxide solution, followed by 1.1 kg of monomer feed 1 and 224 g of monomer feed 2, both added with stirring. On attainment of temperature equilibrium at 80° C., the initiator feed was started.

Initiator feed: 3.43 kg of deionized water and 38.7 g of sodium formaldehydesulfoxylate. The monomer feeds 1 and 2 were started 15 minutes after the start of the reaction. Monomer feed 1: 1.94 kg of butyl acrylate, 5.26 kg of styrene and 387.0 g of polyester P1. Monomer feed 2: 774.1 g of deionized water, 129.0 g of 30% aqueous acrylamide solution, 133.5 g of 50% aqueous 2-acrylamido-2-methylpropanesulfonic acid, 77.4 g of acrylic acid, 348.3 g of methacrylic acid, 46.4 g of 12.5% aqueous ammonia solution, 92.9 g of sodium lauryl sulfate

The pH was adjusted to 4-4.5 during the reaction. On completion of the four-hour monomer feeding period, the initiator feed was continued for one hour and the pH was adjusted to 7.5 with 12.5% ammonia solution.

The solids content was 49.8%, the viscosity was 4500 mPas and the K value was 30. Spray drying afforded a free-flowing powder having a volume average particle size of about 30 μm.

### Example 7

### Preparation of a Crosslinkable Powder Mix E1+V1 with Emulsion Polymer E1 from Example 5

The emulsion polymer E1 from Example 5 was mixed with 10% by weight of triglycidyl isocyanurate (V1) and 0.6% by weight of triphenylethylphosphonium bromide.

### Example 8

### Preparation of a Crosslinkable Powder Mix E1(P1)+V1 with the Modified Emulsion Polymer E1(P1) from Example 6

The emulsion polymer E1(P1) from Example 6 was mixed with 10% by weight of triglycidyl isocyanurate (V1) and 0.6% by weight of triphenylethylphosphonium bromide.

### Example 9

### Preparation with the Emulsion Polymer E1 from Example 5 of a Powder Mix (E1+V1) which is Crosslinkable with Component C)

90 parts by weight of the emulsion polymer E1 and 10 parts by weight of the respective additive C) (Table 1) were mixed with each other. This was followed by the addition of 10% by weight of triglycidyl isocyanurate V1 and 0.6% by weight of triphenylethylphosphonium bromide.

Test Methods:

Rapid Test for Fiber Adhesion:

50.0 g of the fiber material indicated in Table 1 were weighed into a 10 l capacity PE bag (700 mm×350 mm). 50 g of the binder composition indicated in Table 1 were sprinkled onto the fiber material. The PE bag was subsequently inflated with compressed air up to 10 cm below the upper edge and sealed. The bag was then vigorously shaken by hand for 1 minute.

For evaluation, the fiber material with the powder adhering to it was carefully removed from the bag and weighed. The percentage of adherent powder, based on the weight of the fiber material, was determined by the following equation:

Fiber adhesion (% by weight)=[weight (fiber+adherent powder)/weight (fiber used)]×100

The following additives C) were tested:

PVAC=polyvinyl acetate, Festharz B1,5 (Wacker Polymer Systems)

HCO=flakes of hydrogenated castor oil

PVOH=polyvinyl alcohol (degree of hydrolysis=64%)

PES=polyester P1

PA=Schätti Fix 5000 polyamide

PET=polyethylene glycol 2000 polyether

PVB=polyvinyl butyral, LL4140 (Wacker Polymer Systems)

The results are summarized in Table 1:

TABLE 1

| | | E1 + V1 + | E1 + V1 + | E1 + V1 + | E1 + V1 + | E1 + V1 + | E1 + V1 + | E1 + V1 + |
|---|---|---|---|---|---|---|---|---|
| Fiber | E1 + V1 | PVAC | HCO | PVOH | PES | PA | PET | PVB |
| Hemp | 67 | 90 | 80 | 93 | 81 | 75 | 74 | 85 |
| Hemp | 75 | 93 | 86 | 95 | 85 | 82 | 80 | 90 |
| shives | | | | | | | | |
| Kenaf | 60 | 78 | 70 | 82 | 72 | 67 | 69 | 76 |
| Flax | 55 | 84 | 65 | 85 | 68 | 60 | 62 | 78 |
| Poly- | 70 | 94 | 90 | 96 | 88 | 82 | 79 | 92 |
| ester | | | | | | | | |
| Cotton | 75 | 98 | 94 | 99 | 92 | 80 | 83 | 96 |
| Wood | 77 | 98 | 92 | 99 | 90 | 86 | 82 | 97 |
| fiber | | | | | | | | |

The results of Table 1 show that combination with the component C) distinctly improves the fiber adhesion of an adhesive based on a carboxyl-functional styrene-butyl acrylate-methacrylic acid-acrylamide interpolymer E1 (component A) with a triglycidyl isocyanurate crosslinker V1 (component B).

Preparation of Fibrous Moldings for Testing:

To produce compression-molded panels, 115 g of reclaimed cotton were mixed with 13.2 g of binder powder and spread out over an area of 24×24 cm. The fiber-powder mixtures were immediately thereafter compression molded at temperatures of about 180° C. for 5 min to produce rigid panels 2 mm in thickness or flexible panels 10 mm in thickness, each having a basis weight of about 2200 g/m² and a density of about 1115 kg/m³ or 223 kg/m³ respectively.

Test Methods:

Ultimate Tensile Strength UTS:

Test specimens measuring 10 mm×100 mm were die cut from the fibrous compression moldings and tested at room temperature on a Zwick tensile tester similarly to DIN 53857.

Water Imbibition:

The test specimens (dimensions: 50 mm×20 mm) were immersed in water for 1 h or 24 h and the weight increase due to water swelling was determined gravimetrically.

Heat Resistance:

Strips 240 mm×20 mm in length were cut from the test specimens and fixed horizontally on a planar substrate so that the strips overhung the edge of the substrate by 100 mm. In the case of the rigid moldings (panel thickness: 2 mm) a 40 g weight was attached, whereas the flexible moldings (panel thickness: 10 mm) were only subjected to the force of gravity of their own weight. The heat resistance was determined by measuring the deflection d after one hour at T=120° C.

The Test Results are Summarized in Tables 2 and 3:

TABLE 2
Testing of rigid moldings (basis weight 2200 kg/m², density 1115 kg/m²)

| | | | Water imbibition |
|---|---|---|---|
| | UTS | Heat resistance | (1 h/24 h) |
| Batch # | [N] | [mm] | [% by weight] |
| E1 + V1 | 920 | 41 | 18/28 |
| E1 + P1 + V1 | 935 | 25 | 12/22 |
| E1 (P1) + V1 | 945 | 24 | 13/20 |
| S1 | 745 | 45 | 33/45 |
| S1 (P1) | 821 | 34 | 28/29 |
| S1 (P2) | 854 | 31 | 25/28 |

TABLE 3
Testing of flexible moldings (basis weight 2200 kg/m², density 223 kg/m²)

| | | | Water imbibition |
|---|---|---|---|
| | UTS | Heat resistance | (1 h/24 h) |
| Batch # | [N] | [mm] | [% by weight] |
| E1 + Vl | 12 | 49 | 422/431 |
| E1 + P1 + V1 | 13.2 | 22 | 394/410 |
| E1 (P1) + V1 | 13.1 | 20 | 356/376 |
| S1 | 10.1 | 55 | 502/544 |
| S1 (P1) | 11.5 | 35 | 448/471 |
| S1 (P2) | 12.3 | 30 | 435/444 |

The results show that fiber binding with a binder combination of carboxyl-functional styrene-butyl acrylate-methacrylic acid-acrylamide interpolymer E1 (component A) with a triglycidyl isocyanurate crosslinker V1 (component B) improves the mechanical strength and the heat resistance on addition of the polyester P1, whether added subsequently (E1+P1), or during the polymerization (E1(P1)).

A similar result is obtained on using a self-crosslinking epoxy- and carboxyl-functional styrene-butyl acrylate-methacrylic acid-glycidyl methacrylate suspension polymer S1 as component A) which was used in combination with a polyester P1 or P2 as component C).

Determination of Melt Viscosity:

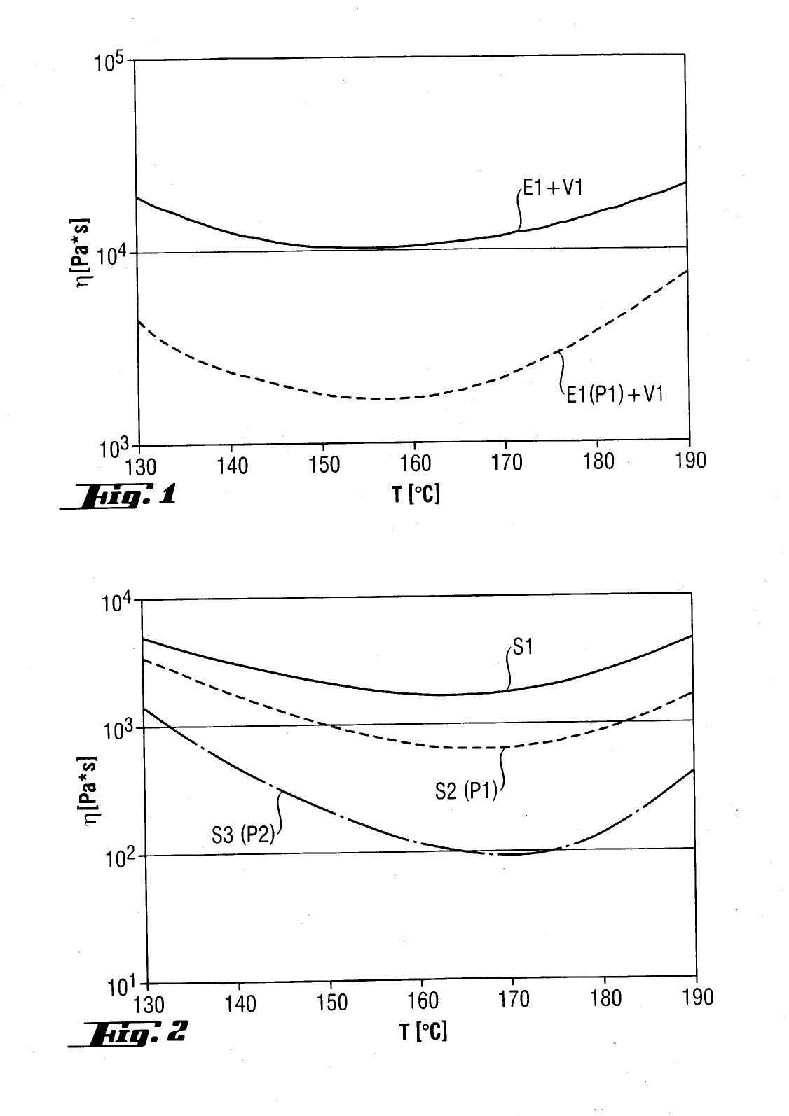

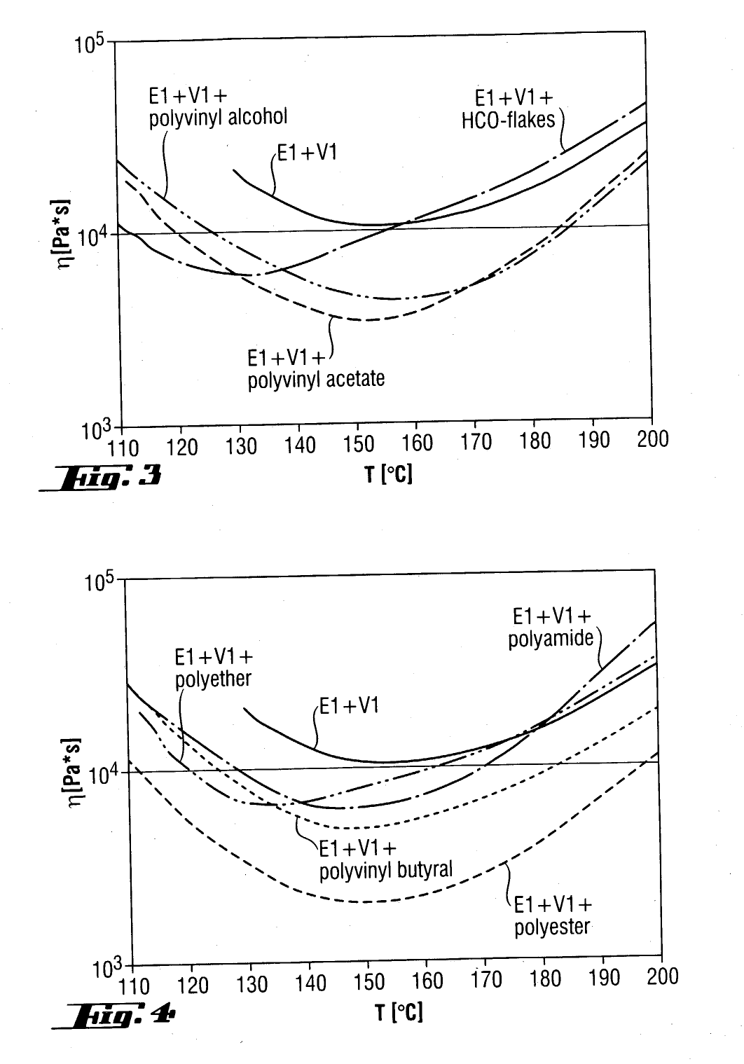

The products of Example 8 (FIG. 1), Examples 2, 3 and 4 (FIG. 2), Example 7 (FIGS. 1, 3 and 4) and Example 9 (FIGS. 3 and 4) were measured using a Bohlin rheometer to record the rheology curves (FIGS. 1 to 4).

Measurement Protocol for Rheology Curves:

Temperature range 110° C. to 200° C., gap spacing 500 μm, frequency 1 Hz, Def 0.05, temperature ramp 5° C./min, oscillating measurement.

The correlation between improved adhesivity on the part of the binder composition according to the present invention and the reduced melt viscosity is evident from FIGS. 1 to 4:

FIG. 1 and FIG. 2 show that copolymerization of component A) in the presence of component C) has the effect that the viscosity of the melt of the binder composition decreases dramatically. FIG. 3 and FIG. 4 reveal that this effect can also be achieved by subsequent addition of component B).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A pulverulent binder composition for binding particulate materials, comprising the components:
A) 10 to 99.99 parts by weight of at least one pulverulent interpolymer having a glass transition temperature Tg or a melting temperature of 230° C. and containing units derived from one or more comonomers
a1) selected from the group consisting of vinyl esters of optionally branched C₁₋₁₈ alkylcarboxylic acids, (methy)acrylic esters of optionally branched C₁₋₁₅ alcohols, dienes, monoolefins, vinyl aromatics and vinyl halides, and
a2) from 0.1 to 50% by weight, based on the total weight of all comonomers, of one or more ethylenically unsaturated comonomers bearing at least one functional group;
B) 0 to 89.99 parts by weight of at least one pulverulent compound different from interpolymer A) which bears two or more functional groups capable of entering into a covalent bond with the functional groups of said interpolymer A); and
C) 0.01 to 90 parts by weight of at least one melt viscosity lowering component selected from the group consising of polyesters, polyamides, polyethers, polyolefins, polyvinyl alcohols, polyvinyl esters, polyvinyl acetals, fatty alcohols, fatty alcohol esters, fatty acids, fatty acid esters, fatty acid amides, fatty acid metal soaps, montan acids, montan acid esters, montan acid soaps, and paraffins, said melt viscosity lowering component having a glass transition temperature Tg or a melting temperature of ≦150° C.,
wherein the parts by weight total 100 parts by weight.

2. The pulverulent binder composition of claim 1, having a melt viscosity of ≦5·10⁴ Pas at 150° C.

3. The pulverulent binder composition of claim 1, wherein said component C) is a compound selected from the group consisting of polyesters of di- and trifunctional aliphatic and cycloaliphatic alcohols with a dibasic carboxylic acid, having an Mw of 2000 to 300,000; polyvinyl alcohols and ethylene-vinyl alcohol copolymers having a degree of hydrolysis of 20 to 100 mol % and an Mw of 3000 to 500,000; polyvinyl acetate and ethylene-vinyl acetate copolymers having an Mw of 5000 to 3,000,000, polyvinyl acetoacetal polymers and polyvinyl butyral polymers having an Mw of 10,000 to 500,000; and fatty acid esters.

4. The pulverulent binder composition of claim 2, wherein said component C) is a compound selected from the group consisting of polyesters of di- and trifunctional aliphatic and cycloaliphatic alcohols with a dibasic carboxylic acid, having an Mw of 2000 to 300,000; polyvinyl alcohols and ethylene-vinyl alcohol copolymers having a degree of hydrolysis of 20 to 100 mol % and an Mw of 3000 to 500,000; polyvinyl acetate and ethylene-vinyl acetate copolymers having an Mw of 5000 to 3,000,000, polyvinyl acetoacetal polymers and polyvinyl butyral polymers having an Mw of 10,000 to 500,000; and fatty acid esters.

5. The pulverulent binder composition of claim 1, wherein said functional comonomers a2) bear one or more functional groups selected from the group consisting of carboxyl groups, hydroxyl groups, amino groups, amido groups, carbonyl groups, alkoxysilane groups, epoxy groups, isocyanate groups, oxazoline groups, aziridine groups and combinations thereof.

6. The pulverulent binder composition of claim 5 wherein said amido group is an N-alkylolamide group.

7. The pulverulent binder composition of claim 1, wherein component B) is present and comprises 0.1 to 50 parts by weight of at least one pulverulent compound having two or more epoxy or isocyanate groups and having a melting point of 40° C. to 150° C.

8. The pulverulent binder composition of claim 1, wherein component B) comprises an interpolymer of one or more monomers b1) selected from the group consisting of vinyl esters of optionally branched C₁₋₁₈ alkylcarboxylic acids, (meth)acrylic esters of optionally branched C₁₋₁₅ alcohols, dienes, olefins, vinyl aromatics and vinyl halides with functional groups b2) capable of entering into a covalent bond with functional groups of interpolymer A).

9. A process for preparing the pulverulent binder composition of claim 1, comprising mixing component C) as a powder with component A) and component B); adding component C) during the polymerization of comonomers during preparation of interpolymer A) or optionally B); or mixing component C) in the form of an aqueous dispersion with dispersions of said interpolymers A) and/or B) to form a dispersion mixture and subsequently drying the dispersion mixture; or coextruding components A), optionally component B), and component C) in the form of their melts and grinding a solidified extrusion product.

10. A process for producing moldings from particulates comprising adding the pulverulent binder composition of claim 1 to particulate material and curing to form a molded product.

11. The process of claim 10, wherein said particulates comprise mineral materials, synthetic materials, natural materials or mixtures thereof.

12. The process of claim 10, wherein said particulates of mineral materials, synthetic materials or natural materials comprise mineral fibers, synthetic fibers, natural fibers, or mixtures thereof.
